(19) United States
(12) Patent Application Publication
(10) Pub. No.: US 2002/0103996 A1
(43) Pub. Date: Aug. 1, 2002

(54) Method and system for installing an operating system

(76) Inventors: Joshua T. LeVasseur, San Francisco, CA (US); Adam Stone, Palo Alto, CA (US)

Correspondence Address: PERKINS COIE LLP, PATENT-SEA, P.O. BOX 1247, SEATTLE, WA, 98111-1247, US

(21) Appl. No.: 09/773,761

(22) Filed: Jan. 31, 2001

(51) Int. Cl. G06F 9/00

(52) U.S. Cl. 713/2

(57) ABSTRACT

A method and system for selectively installing different operating systems on computers. The configuration system initially installs a first operating system, such as a Linux-based operating system, on each of the computers. This installation process may require the manual insertion of a floppy disk or CD-ROM into the computer. Once the first operating system is installed, the second operating system, such as the NT operating system, can be installed without manual intervention at the computer. The configuration system directs the installation of the second operating system via a local area network that is connected to an installation server.

### TECHNICAL FIELD

The described technology relates generally to installing an operating system on a computer.

### BACKGROUND

Many organizations (e.g., corporations) have found it desirable to provide web sites through which users (e.g., customers) can access the web pages of the organization. These web sites may be used to conduct electronic commerce or to disseminate information about the organization. The goal of many of these organizations is to have as many users as possible visit their web sites. In order to support a large number of visits, these organizations often develop complex computer system infrastructures. These infrastructures may include firewalls, load balancers, web servers, application servers, and so on. As the number of visits increases, additional computers need to be added to the infrastructure. Organizations may find it very expensive and time consuming to design, build, and maintain the necessary computer system infrastructure using their internal information technology group. In addition, there may be a shortage of information technology personnel who are qualified to work on such computer system infrastructures. As a result, these organizations may outsource the management of their web sites to a hosting service.

A hosting service may provide the infrastructure, both hardware and software, to support the web sites of their customer organizations. The customer organizations need only provide their domain-specific applications, which can be served by the computer system infrastructure of the hosting service. The use of a hosting service allows a customer organization to concentrate its efforts on its domain-specific applications, and allows the hosting service to cost effectively manage the infrastructure needed by multiple customer organizations. FIG. 1 is a block diagram illustrating an example infrastructure that may be provided by a hosting service. The hosting service computer center 100 may include customer systems 110, 120, and 130 for different customer organizations. Each customer system may be implemented as a tiered architecture that includes a firewall, a web server, an application server, a database server, and a mass storage device. Each tier may include multiple components (e.g., computers) for providing the functionality of that tier. Additional components can be added to a tier as demand for a customer system increases. For example, the customer system 110 may initially include only two web servers. As traffic to the web site increases, a third web server can be added to the web server tier. The customer systems may include load balancing hardware between each tier to distribute the workload among the components of the next lower tier. The firewalls limit Internet access to only message formats that conform to certain protocols (e.g., HTTP protocol). The web servers receive HTTP request messages, invoke the services of the application servers, and then provide HTTP response messages to the users. The application servers provide domain-specific applications for the customer organizations. The database servers may be conventional database systems with domain-specific data. One skilled in the art will appreciate that there are many possible variations to the overall architecture of the infrastructure.

It is important for a hosting service to be able to rapidly add components as the needs of their customer organizations change. For example, if the number of HTTP request messages exceeds the capacity of the web servers of a customer system, then additional web servers need to be added to the customer system. It can, however, be very time-consuming to install the appropriate operating system on the web server that is to be added. If a hosting service supported only one operating system, then each computer (e.g., web server) could be pre-loaded with that operating system. To meet the needs of its customers, a hosting service, however, needs to support more than one operating system. In particular, web sites typically use a Linux-based operating system, such as that provided by Red Hat, Inc., or the NT operating system provided by Microsoft Corporation. The installation of an operating system on a computer typically requires manual intervention, such as inserting a floppy disk or CD-ROM into the computer. This manual intervention increases the time needed to add computers to a customer system. It would be desirable to have a technique for installing different operating systems quickly and without manual intervention after it is determined which operating system needs to be installed on a computer.

### BRIEF DESCRIPTION OF THE DRAWINGS

FIG. 1 is a block diagram illustrating an example infrastructure that may be provided by a hosting service.

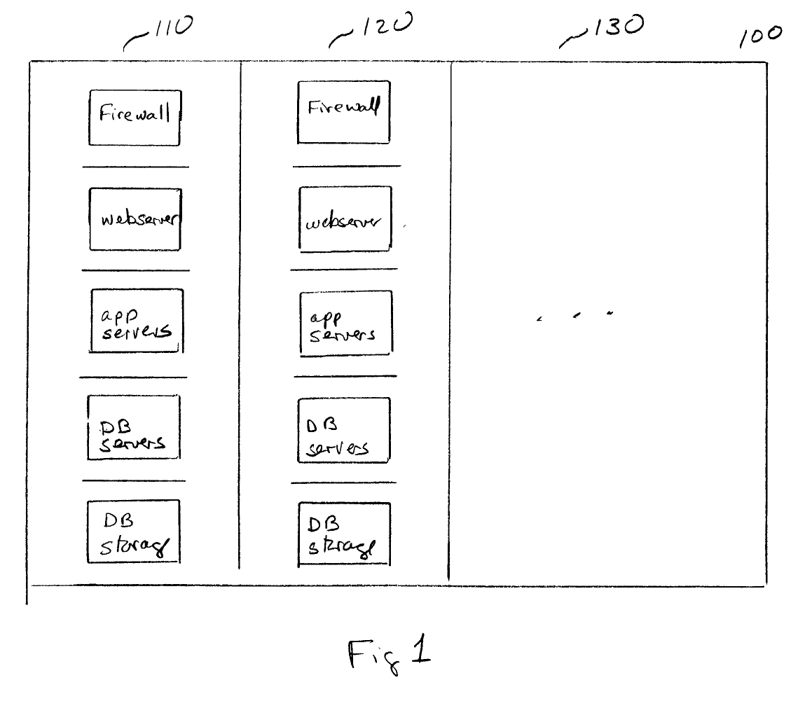

FIG. 2 is a block diagram illustrating components of the configuration system.

FIG. 3 is a block diagram illustrating the layout of the FAT file system.

FIG. 4 is a flow diagram illustrating the processing of the configuration system when a bootable FAT partition can be located after the Linux operating system.

FIG. 5 is a flow diagram illustrating the processing of the configuration system when a bootable FAT partition cannot be located after the Linux operating system.

### DETAILED DESCRIPTION

A method and system for selectively installing different operating systems on computers is provided. In one embodiment, the configuration system initially installs a first operating system, such as a Linux-based operating system, on each of the computers. This installation process may require the manual insertion of a floppy disk or CD-ROM into the computer. Once the first operating system is installed, the second operating system, such as the NT operating system, can be installed without manual intervention at the computer. The configuration system directs the installation of the second operating system via a local area network that is connected to an installation server. In this way, the second operating system can be installed on a computer for a customer system without manual intervention after it is determined that the second operating system is to be installed.

The configuration system initially installs a Linux-based operating system on the hard drive of each computer, which may require the insertion of a floppy disk or CD-ROM. If a computer with the Linux operating system is to be added to a customer system, then that computer will already have the appropriate operating system installed. If, however, a computer with the NT operating system is to be added to a customer system, then the configuration system installs a Linux-based initiate installation program on the computer. The Linux-based initiate installation program uses the services of the installed Linux-based operating system to create a partition for a file allocation table (“FAT”) file system on the hard drive of the computer. The FAT file system was initially designed for use by the disk operating system (“DOS”) by Microsoft Corporation. The FAT partition includes a boot record (or boot sector) that includes sizing information about the partition boot code. The program then stores in the FAT partition the DOS network driver that is needed to access the installation server via a local area network. The program also stores a DOS-based initiate installation program to initiate the installation process from the installation server. The program then sets the computer to boot in accordance with the FAT partition. The program then signals to boot the computer. The computer boots to DOS as indicated by the FAT partition. As DOS starts up, it executes the DOS-based initiate installation program, which may be identified in an automatic execution batch file (i.e., “autoexec.bat”). The DOS-based initiate installation program creates a FAT partition for the NT operating system, maps the networks drive of the installation server, and runs the NT installation program from the network drive. Upon completion of the installation, the computer is configured to execute the NT operating system.

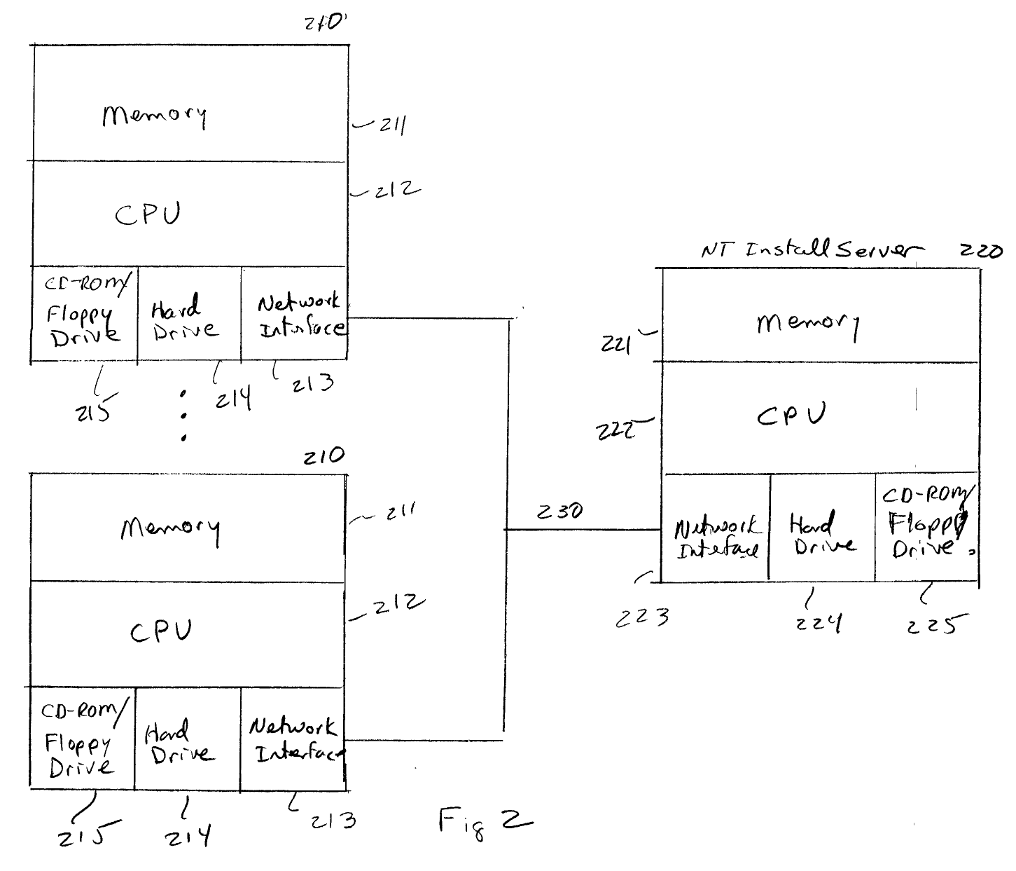

FIG. 2 is a block diagram illustrating components of the configuration system. The computers 210, which are available to be added to a customer system, are connected to the NT installation server 220 via a local area network 230. The computers 210 may include main memory 211, a central processing unit 212, input devices (e.g., keyboard and pointing devices), output devices (e.g., display devices), a network interlace adapter 213, a hard drive 214, and a CD-ROM or floppy disk drive 215. The main memory, hard drive, CD-ROM, and floppy drive are computer-readable media that may contain instructions for implementing the configuration system. Communication channels other than a local area network, such as the Internet, a wide area network, or point-to-point dial-up connections may be used to connect the computers to the NT installation server. The NT installation server 220 includes main memory 221, a central processing unit 222, a network interface adapter 223, a hard drive 224, and a CD-ROM or floppy disk drive 225. The computers 210 are initially loaded with the Linux operating system and the Linux-based initiate installation program. (Alternatively, the loading of the Linux-based initiate installation program can be deferred until it is determined that the NT operating system should be installed on the computer.) The Linux-based program controls creating the FAT partition, loading the DOS network driver into the FAT partition, loading the DOS-based initiate installation program, setting the computer to boot in accordance with the FAT partition, and booting the computer. When booted, the computer installs the DOS network driver and starts executing the DOS-based initiate installation program. The DOS-based initiate installation program creates a FAT partition for the NT operating system and directs the installation server to install the NT operating system on the computer.

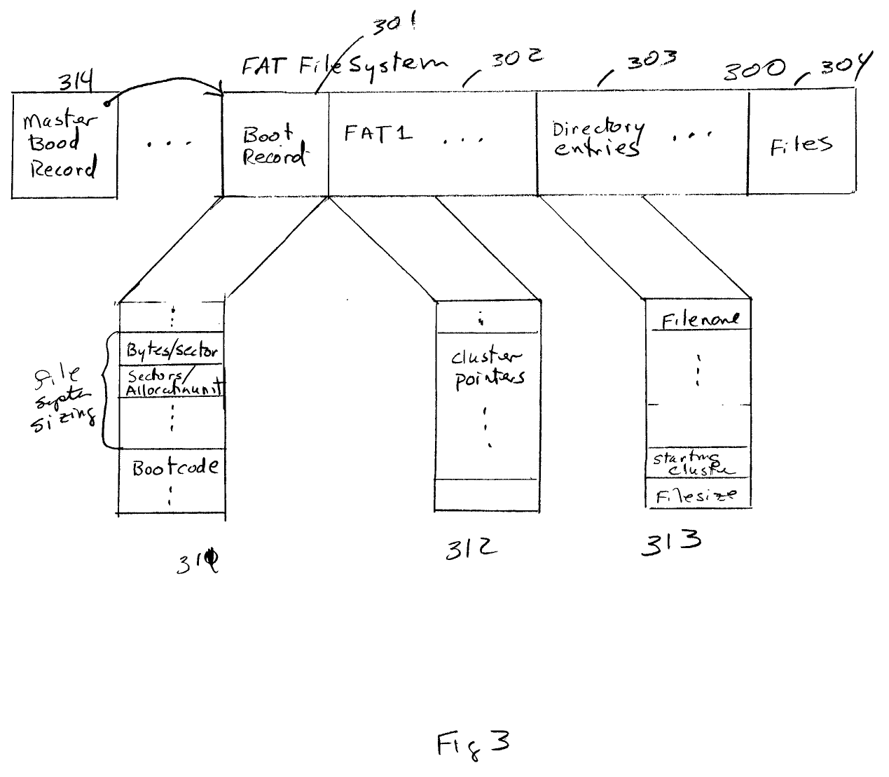

FIG. 3 is a block diagram illustrating the layout of the FAT file system. The FAT file system 300 includes a boot record 301, file allocation tables 302, directory entries 303, and a file storage area 304. Block 311 illustrates the layout of the boot record. The boot record includes file system sizing information and boot code. The file system sizing information includes the number of bytes per sector, number of sectors per allocation unit, and so on. The boot code is executed when the computer system boots to the FAT partition. Block 312 illustrates the layout of a file allocation table. The file allocation tables include cluster pointers linking the various clusters that comprise a file of the file system. Block 313 illustrates the layout of a directory entry. The directory entries describe the hierarchical organization of the files stored in the file system. The entries include the name of the file, the number of the starting cluster for the file, the file size, and so on. In one embodiment, the Linux loader (“LiLo”) controls the setting of the master boot record 314 to point to the boot record of the FAT partition. In an alternate embodiment, the master boot record does not include a large enough field to point to a FAT partition that is installed at a location after the installed Linux operating system. In such a case, the configuration system boots the Linux operating system from a RAM disk and then executes the Linux-based initiate installation program that is stored on the RAM disk.

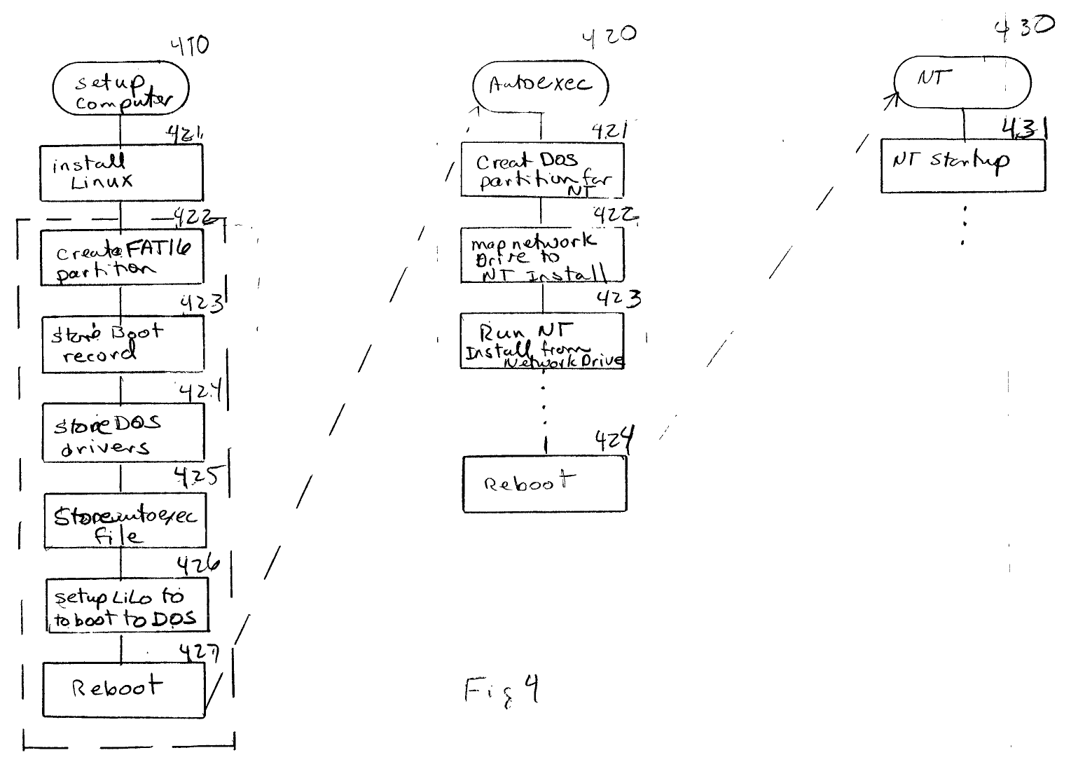

FIG. 4 is a flow diagram illustrating the processing of the configuration system when a bootable FAT partition can be located after the Linux operating system. Flow diagram 410 illustrates the initial setup of a computer. In block 421, the configuration system installs both the Linux operating system on the computer and the Linux-based initiate installation program for performing the processing of blocks 422-427. The processing of blocks 422-427 can be performed from any time after the installation of the Linux operating system until the time the NT operating system is to be installed on the computer. For example, blocks 422-425 can be performed as soon as the Linux operating system is installed, and the performance of blocks 426-427 can be delayed until it is decided that the NT operating system should be installed on the computer. Alternatively, the performance of blocks 422-427 can be delayed until it is decided that the NT operating system should be installed on the computer. In block 422, the configuration system creates a 16-bit FAT partition on the hard drive of the computer. In block 423, the configuration system stores the boot record in the created FAT partition. In block 424, the configuration system stores the DOS network drivers needed to access the NT installation server in the FAT partition. In block 425, the configuration system stores the DOS-based initiate installation program in the FAT partition and sets the automatic execution batch file to execute that program. In block 426, the configuration system sets the Linux loader to boot to DOS in accordance with the FAT partition. In block 427, the configuration system reboots the computer. Once booted, the processing continues at flow diagram 420. Flow diagram 420 illustrates the processing of the DOS-based initiate installation program. In block 421, the program creates a FAT partition for the NT operating system. In block 422, the program maps the network drive of the NT installation server. In block 423, the program starts the execution of the NT installation program from the network drive. Upon completion of the installation, the program boots the computer to boot to the NT operating system as indicated by flow diagram 430.

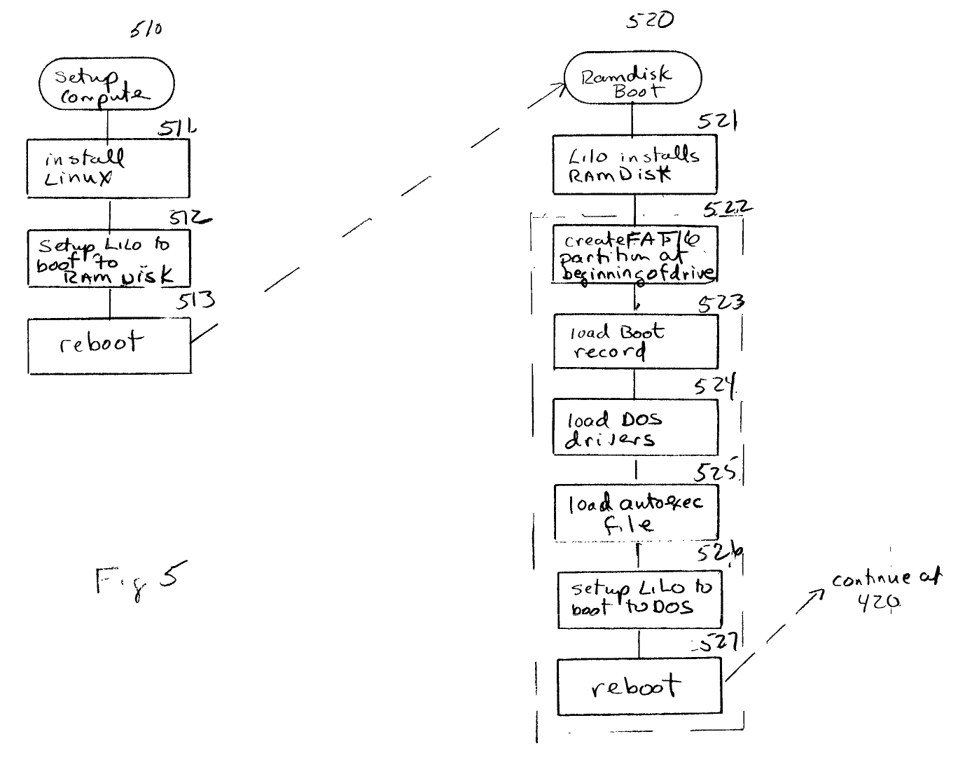

FIG. 5 is a flow diagram illustrating the processing of the configuration system when a bootable FAT partition cannot be located after the Linux operating system. Flow diagram 510 illustrates the initial setup of the computer. In block 511, the configuration service installs Linux on the computer. In block 512, the configuration system sets the Linux loader to boot to RAM disk. The RAM disk is configured to execute the Linux-based initiate installation program. In block 513, the configuration system boots the computer system. Flow diagram 520 illustrates the processing of the Linux-based initiate installation program. In block 521, the Linux loader loads the RAM disk, which contains the Linux-based initiate installation program, and then directs the execution of that program. Blocks 522-527 operate in a similar manner to blocks 422-427, and the processing then continues at flow diagram 420.

Based on the above description, it will be appreciated that although specific embodiments of the configuration system have been described for purposes of illustration, various modifications may be made without deviating from the spirit and scope of the invention. Accordingly, the invention is not limited except by the appended claims.

1. A method in a computer for booting a computer, the method comprising:
installing a Linux-based operating system on a hard drive of the computer;
creating a FAT partition on the hard drive using services of the installed Linux-based operating system, the FAT partition having a boot record and an initiate installation program;
setting the computer to boot in accordance with the boot record of the FAT partition; and
booting the computer wherein the computer boots in accordance with the boot record of the FAT partition and executes the initiate installation program.

2. The method of claim 1 wherein the boot record controls the booting to DOS.

3. The method of claim 2 including storing a network device driver in the FAT partition so that the initiate installation program can access a network device.

4. The method of claim 3 wherein the initiate installation program creates a partition for an NT operating system and controls the installation of the NT operating system from the network device onto the hard drive.

5. The method of claim 4 including upon installation of the NT operating system booting the computer wherein the computer boots to the installed NT operating system.

6. The method of claim 1 wherein the creating of the FAT partition, setting of the computer to boot, and the booting of the computer occur after identifying that the NT operating system is to be installed on the computer.

7. The method of claim 1 wherein the setting of the computer to boot in accordance with the boot record of the FAT partition occurs after identifying that the NT operating system is to be installed on the computer.

8. A method for installing an NT operating system on a computer with a different operating system currently installed on the computer, the method comprising:
creating a FAT partition on the computer, the FAT partition having a boot record for booting to DOS, having a network device driver, and having a DOS-based initiate installation program;
setting the computer to boot to DOS in accordance with the boot record of the created FAT partition; and
booting the computer wherein the computer boots to DOS in accordance with the boot record and the DOS-based initiate installation program uses the network device driver to initiate installation of the NT operating system from a network device onto the computer.

9. The method of claim 8 including after installing the NT operating system booting the computer wherein the computer boots to the NT operating system.

10. The method of claim 8 wherein the creating occurs before and the setting and booting occur after identifying that the NT operating system is to be installed on the computer.

11. The method of claim 8 wherein the creating occurs after identifying that the NT operating system is to be installed on the computer.

12. The method of claim 8 wherein the DOS-based initiate installation program creates a partition for the NT operating system.

13. The method of claim 8 wherein the different operating system is a Linux-based operating system.

14. The method of claim 8 including before creating the FAT partition setting the computer to boot in accordance with a RAM disk, the RAM disk having a Linux-based initiate installation program.

15. A method for selectively installing different operating systems on computers, the method comprising:
installing a first operating system on each of the computers;
using services of the first operating system,
creating a file system partition on a storage device of the computers, the file system partition having information for installing the second operating system on the computer; and
upon receiving an indication that the second operating system is to be installed on a computer,
setting the computer to boot in accordance with the created file system partition; and
booting the computer wherein the computer boots in accordance with the created file system partition and installs the second operating system on the computer using the information of the file system partition.

16. The method of claim 15 wherein the file system partition is a FAT partition.

17. The method of claim 15 wherein the first operating system is a Linux-based operating system and the second operating system is an NT operating system.

18. The method of claim 15 wherein the file system partition is created upon receiving the indication that the second operating system is to be installed on the computer.

19. The method of claim 15 wherein the second operating system is installed from a network device.

20. The method of claim 15 wherein the created file system partition includes a network device driver for accessing a network device from which the second operating system is to be installed.

21. An apparatus for selectively installing different operating systems on computers, each computer installed with a first operating system, comprising:
means for creating a file system partition on the computers, the file system partition having information for installing the second operating system on the computer;
means for setting the computer to boot in accordance with the created file system partition; and
means for booting the computer wherein the computer boots in accordance with the created file system partition and installs the second operating system on the computer in accordance with the information of the file system partition.

22. The apparatus of claim 21 wherein the file system partition is a FAT partition.

23. The apparatus of claim 21 wherein the first operating system is a Linux-based operating system and the second operating system is an NT operating system.

24. The apparatus of claim 21 wherein the file system partition is created upon receiving an indication that the second operating system is to be installed on the computer.

25. The apparatus of claim 21 wherein the second operating system is installed from a network device.

26. The apparatus of claim 21 wherein the created file system partition includes a network device driver for accessing a network device from which the second operating system is to be installed.

27. The apparatus of claim 21 including means for booting the computer system from a RAM disk that provides means for creating a file system partition, means for setting the computer to boot in accordance with created file system partition, and means for booting the computer.

28. A computer-readable medium including instructions for controlling a computer installed with a Linux-based operating system to install an NT operating system by a method comprising:
creating a FAT partition on the computer, the FAT partition having a boot record for booting to DOS, having a network device driver, and having a DOS-based initiate installation program;
setting the computer to boot to DOS in accordance with the boot record of the FAT partition; and
booting the computer wherein the computer boots to DOS in accordance with the boot record and the DOS-based initiate installation program uses the network device driver to install the NT operating system from a network device onto the computer.

29. The computer-readable medium of claim 28 including after installing the NT operating system onto the computer booting the computer wherein the computer boots to the NT operating system.

30. The computer-readable medium of claim 28 wherein the setting and booting occur after identifying that the NT operating system is to be installed on the computer.

31. The computer-readable medium of claim 28 wherein the creating occurs after identifying that the NT operating system is to be installed on the computer.

32. The computer-readable medium of claim 28 wherein the DOS-based initiate installation program creates a partition for the NT operating system.

33. The computer-readable medium of claim 28 including before creating the FAT partition setting the computer to boot in accordance with a RAM disk, the RAM disk having instructions for controlling the creating of the FAT partition and setting of the computer to boot to DOS.

34. A method of selectively installing different operating systems on computers, the method comprising:
installing a first operating system on the computers; and
upon receiving an indication that a computer is to be configured with a second operating system,
setting the computer to boot in accordance with a file system partition, the file system partition having information for installing the second operating system on the computer, the second operating system being installed from a network device; and
booting the computer to effect the installation of the second operating system from the network onto the computer.

35. The method of claim 34 wherein the first operating system is a Linux-based operating system and the second operating system is the NT operating system.

36. The method of claim 34 wherein the file system partition is a FAT-based partition.

37. The method of claim 34 wherein the file system partition includes a boot record for booting to DOS and a program for initiating the installation of the second operating system.

38. The method of claim 34 including before setting the computer to boot in accordance with the file system partition, booting the computer to RAM disk that controls setting the computer to boot in accordance with the file system partition.

39. The method of claim 34 including after installing the first operating system, creating the file system partition.
